(19) United States
(12) Patent Application Publication
(10) Pub. No.: US 2006/0289113 A1
(43) Pub. Date: Dec. 28, 2006

(54) Method for curing adhesive joints using interference-free microwave irradiation

(76) Inventors: Elisabeth Cura, Duesseldorf (DE); Rolf Hempelmann, St.Ingbert (DE); Heidi Schweitzer, Pfungstadt (DE); Hans M. Sauer, Darmstadt (DE); Stefan Spiekermann, Darmstadt (DE)

Correspondence Address: HENKEL CORPORATION, THE TRIAD, SUITE 200, 2200 RENAISSANCE BLVD., GULPH MILLS, PA, 19406, US

(21) Appl. No.: 11/495,367

(22) Filed: Jul. 28, 2006

Related U.S. Application Data
(63) Continuation of application No. PCT/EP04/10424, filed on Sep. 17, 2004.

(30) Foreign Application Priority Data
Jan. 29, 2004 (DE) 100 2004 004764.2

(51) Int. Cl. B32B 37/00

(52) U.S. Cl. 156/272.4; 156/275.7; 156/379.6

(57) ABSTRACT

A method is provided for manufacturing a component having two individual or shaped parts to be connected using an adhesive containing a magnetic filler and capable of being cured by heat. At least one part of the component, in particular the adhesive joint lying between the parts, is exposed to circularly polarized electromagnetic radiation, particularly in the microwave wavelength range, in order to apply heat to the adhesive.

### CROSS-REFERENCE TO RELATED APPLICATIONS

This application is a continuation under 35 USC Sections 365(c) and 120 of International Application No. PCT/EP2004/010424, filed 17 Sep. 2004 and published 11 Aug. 2005 as WO 2005/073329, which claims priority from German Application No. 102004004764.2, filed 29 Jan. 2004, each of which is incorporated herein by reference in its entirety.

### FIELD OF THE INVENTION

The present invention relates to a method for manufacturing a component having two individual or shaped parts to be connected lying on each other with an adhesive which can be cured by heat lying between the parts, a magnetic filler being added to the adhesive, at least one part of the component, in particular the adhesive joint lying between the parts, being exposed to polarized electromagnetic radiation, particularly in the microwave wavelength range. The invention also relates to a device for carrying out the method.

### DESCRIPTION OF THE RELATED ART

Such methods for the radiation-assisted curing of adhesives are known. In particular, methods in which substrates such as adhesive, filled in particular with nanoparticles, are heated and thus cured by irradiating them with microwaves (MW) whose energy is absorbed by the nanoparticles are known, e.g., from DE 10 037 883 A1. For instance, adhesives filled with a nanoscale ferrite are rendered more capable of absorbing microwaves, particularly when, in addition to the MW irradiation, they are exposed to a static magnetic field which causes a premagnetization of the ferrites. The nanoparticles aligned in this way receive sufficient energy from the microwave field in order to heat and thus cure the adhesive.

To this end, for the adhesive bonding of shaped parts, microwaves are fed along a linear adhesive joint in a microwave guide, in particular a hollow guide or a coaxial guide, which carries the radiation energy along the adhesive joint. The fraction of the radiation energy not absorbed by the adhesive joint at the end of the waveguide is reflected back to the energy source, a part of the remaining radiation in turn being converted into heat along the return path. Owing to the formation of interference, however, this reflection leads to an undesired side effect. The waves traveling forward and back are superposed and form a standing wave, which is distinguished by static intensity minima and maxima. The adhesive joint is correspondingly heated differently owing to the local intensity variations due to the minima and maxima.

The adhesive is then heated more strongly at the intensity maxima than at the intensity minima. This leads to non-uniform curing of the adhesive within the adhesive joint. It is particularly critical when the intensity at the minima is cancelled out almost completely. The situation may then arise that the adhesive is not cured at all, while it is overheated and destroyed at the positions of the interference maxima owing to the increased radiation density. The adhesive joint is weakened at many positions as a result of this effect, the spacing of intensity maxima and minima being from 3 to 5 cm at a working frequency of 2.45 GHz, depending on the waveguide. Particularly for the adhesive bonding of plastics, however, in contrast to the adhesive bonding of metal parts, the low thermal conductivity of the plastic prevents the temperature distribution from being equalized between the maxima and minima by heat conduction inside the component.

Such problems occur particularly when the waveguide is not rectilinear but, as is normal for the adhesive bonding of shaped automobile parts, follows a complicated adhesive joint with many bends, corners and branches. The perturbing interference is then caused not only by wave reflection at the end of the waveguide, but also by reflection at the bends and corners. In these cases, the resulting interference pattern can be extremely complicated and vary greatly even if there are only minor deformations of the resonator, for instance when applying pressure to the shaped parts in the bonding press. Furthermore, this problem can scarcely be countered by compensating measures, such as additional MW correction elements, since not only the bends and the corners in the waveguide but also the nonuniformities in the shaped parts and in the adhesive joint have similar consequences.

It is true that the nonuniform heating caused by interference can be partially avoided by the use of MW absorbers, in particular by special ferrites with a defined Curie temperature, so that overheating at the intensity maxima is substantially prevented; this does not, however, avoid insufficient supply of microwave energy to the adhesive joint at a pronounced interference minimum. It is indeed possible to improve the heating by stronger irradiation and longer irradiation times. However, longer irradiation times lose the main advantage of MW adhesive bonding, i.e., the very rapid and smooth adhesive curing.

Another possible way of avoiding the consequences of MW interference for the adhesive strength consists in varying the interference pattern. To this end, mobile reflectors are installed at the end of the MW line. The effect of these is that the interference pattern is moved periodically to and fro at certain time intervals and, at least in the case of an ideal entirely rectilinear adhesive joint, sufficient energy is supplied to every position in the course of the irradiation time. This method is comparatively elaborate, however, and does not work for complicatedly shaped adhesive joints with bends and kinks since, as mentioned, the reflection is caused not only by the end of the MW line but also by the random nonuniformities in the adhesive joint thickness.

It is therefore an object of the present invention to improve an adhesive bonding method, in particular adhesive bonding assisted by MW irradiation, especially with a view to large components such as bodywork parts, so as to ensure maximally homogeneous curing of the adhesive joints and therefore reliable adhesive bonding of the parts by simple implementation of the method. It is a further object of the invention to provide a simple and cost-effective device to assist the curing of adhesive joints, with which large components can be processed and which leads to homogeneous curing of the adhesive joints and therefore to stable adhesive joints.

### BRIEF SUMMARY OF THE INVENTION

The present invention provides a method for manufacturing a component comprising at least two parts to be joined with an adhesive which can be cured by heat lying between the parts and forming an adhesive joint and which comprises a magnetic filler, said method comprising exposing at least one portion of the component to polarized electromagnetic radiation having a magnetic component which is circularly polarized so that heat is applied to the adhesive. Also provided is a device suitable for carrying out such method, the device comprising a means for applying heat to a component, the component having at least two parts to be connected with an adhesive joint arranged between said two parts, the adhesive joint containing an adhesive which can be cured by heat and the means for applying heat comprising a waveguide for electromagnetic radiation having a magnetic component, wherein the waveguide is designed so that the electromagnetic radiation coupled in through an opening has a circular polarization of the magnetic component.

### BRIEF DESCRIPTION OF THE FIGURES

FIG. 1 shows a rectangular waveguide with a TE-(1.0) wave.

FIG. 2 shows a microwave waveguide for the adhesive bonding of a joint.

### DETAILED DESCRIPTION OF CERTAIN EMBODIMENTS OF THE INVENTION

The essential basic idea of the invention is to polarize the radiation not linearly as before, but instead circularly. This procedure firstly utilizes the effect that the direction of the polarization is reversed upon reflection. In the case of the examples described here, which preferably employ an adhesive provided with nanoscale ferrite, the magnetic field of the radiation is circularly polarized since this will be absorbed by the adhesive and therefore leads to curing. If a circularly polarized wave is thus applied onto an adhesive joint from one direction, then its polarization will rotate differently than the polarization of the wave reflected back mirror-symmetrically. According to the invention, the adhesive with the magnetic component contained in it is sensitized to the direction of the polarization so that it can absorb energy only from waves of the one polarization direction. No interference can take place inside the adhesive in this case, so that there is no formation of maxima and minima with the problematic differential curing. The type of radiation according to the invention therefore leads to an energy supply that is homogeneous over the adhesive joint.

The essential advantage of the procedure according to the invention therefore resides in the homogenization of the heat application and therefore the curing. This advantage is important particularly for components that are relatively large in relation to the wavelength of the radiation used. In the case of irradiation with microwaves, this method is particularly preferable especially for large components with external dimensions of more than 10 cm, such as bodywork parts, supporting surfaces, etc.

As already mentioned, the method according to the invention can be used particularly simply and therefore advantageously when magnetizable nanoparticles, in particular nanoscale ferrites (nanoferrites) are added as a magnetic component to the adhesive. Such ferrite additives are sufficiently well known, and are described, e.g., in DE 10 037 883 A1. The nanoparticles have a particle size of between 2 nm and 100 nm, a particle size of about 5 nm being preferred. The previously known nanoferrites may also be used in full scope for the application of circularly polarized radiation according to the invention. The temperature limitation due to the Curie effect of the ferrites is unconditionally effective. Compared to the methods which use mobile wave reflectors, the advantage of using nanoferrites resides in the fact that no mechanically moved elements are required in the waveguide. Furthermore, the method works even for complicatedly shaped waveguides in which waves are reflected not only from the walls of the waveguide but also from obstacles and inhomogeneities along the adhesive joint.

With a view to using an adhesive provided with such nanoparticles, it is not only particularly advantageous but virtually indispensable that the component, or the adhesive joint, is additionally exposed during the irradiation to a static magnetic field which causes a premagnetization of the nanoparticles. This field with a strength of up to 10 T may be generated either by permanent magnets or by excited coils, the use of electromagnets to generate the DC magnetic field being associated with a high energy demand. The nanoparticles used have a saturation magnetization of between 20 mT and 2.5 T, in particular between 100 mT and 500 mT. The nanoparticles are sensitized by the static magnetic field to absorption of the polarized microwaves insofar as the nanoferrites so to speak form small gyroscopes aligned with their magnetic field in a particular direction.

In order to achieve maximally effective application of the circularly polarized component of the magnetic field to the adhesive joint, it is particularly advantageous for the waveguide or the resonator to have a geometry adapted in respect of the wavelength to be used and the profile of the adhesive joint. It is thus very advantageous to adapt the resonator individually to the component to be adhesively bonded, or the adhesive joint to be exposed. It is preferable to design the waveguide so that the microwave radiation has a maximally pure circular polarization in the adhesive joint region. It is furthermore of crucial importance for the polarization plane, i.e., the plane in which the magnetic field vector of the MW radiation rotates, to be perpendicular to the cross-sectional plane of the waveguide. The direction of the static magnetic field inside the adhesive joint is also preferably oriented perpendicularly to the polarization plane.

The functionality of a preferred configuration of the method is ultimately based on two features relating to magnetic nanoparticles and microwaves: in a static magnetic field which is dimensioned so that the nanoparticles experience the state of ferromagnetic resonance (FMR), nanoparticles have a pronounced electromagnetic dichroicity. This means that they absorb exclusively the polarized wave whose polarization vector rotates clockwise (right-circularly) as viewed in the direction of the field lines of the DC magnetic field. On the other hand, left-circularly polarized waves are not absorbed and pass through an adhesive filled with nanoferrites without attenuation, and therefore without contributing to its heating. Furthermore, as explained, circularly polarized waves traveling through a waveguide will be reflected back from its end or from an obstacle and therefore reverse their polarization sense according to the laws of optical reflection, so long as the polarization plane is perpendicular to the mirror plane. Waves traveling forward with right-circular polarization are therefore converted by the reflection into left-circular returning waves, and vice versa.

Because nanoferrites present in the adhesive joint absorb only waves with one of the two possible polarization directions, but not the wave reflected back mirror-symmetrically, no interference phenomenon occurs. Depending on the polarity of the applied DC magnetic field, either only the forward wave or the returning wave will be absorbed. In no case, however, are maxima and minima in the temperature profile incurred along the adhesive joint because of interference. The MW absorption along the adhesive joint is now uniform.

As already explained, the magnetic component of the microwave field is responsible for the described energy transmission to the nanoferrites. On the other hand, the electric component of the field leads to dielectric heating which is caused not by the nanoferrites but by the polar components of the adhesive and the parts to be joined. In contrast to linear polarization, in the case of circularly polarized waves it is not possible to find a position in the resonator where the magnetic component is maximal and the electric component of the field is virtually zero, at which the adhesive joint will advantageously be arranged. It is therefore particularly preferable to take other precautions so that the dielectric heating cannot overcome the intrinsic temperature limitation due to the nanoferrites. In particular, by using suitable materials of the parts to be joined and/or suitable adhesives, it is possible to ensure that excessive dielectric MW absorption does not take place in the parts to be joined. Many simple or glass-fiber reinforced plastics for instance, plus glass and ceramic in combination with polyurethanes or even epoxy adhesives and “hotmelts”, are relatively insensitive to dielectric heating. Although in principle it is possible to carry out unilateral point-wise adhesive bonding of metal parts by using circular waves, this is less relevant since there is the interference problem in the case of point adhesive bonds.

Owing to the high quality of the adhesive joint irradiated according to the invention, the adhesively bonded components are available for further processing immediately after the adhesive bonding, without having to wait a long time for complete curing of the adhesive joint. In the context of manufacturing the components to be adhesively bonded, this leads to a great shortening of the cycle times and to a reduction of waste.

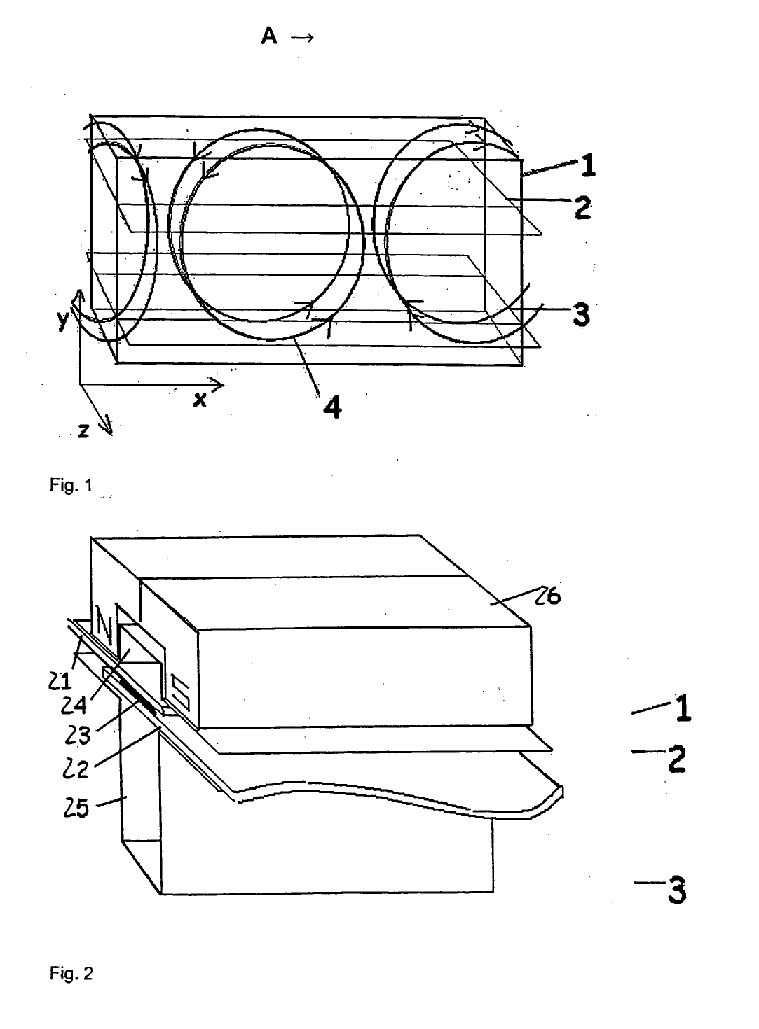

The invention will be described in more detail below with the aid of exemplary embodiments and FIGS. 1 and 2, in which:
FIG. 1 shows a rectangular waveguide with a TE-(1.0) wave, and
FIG. 2 shows a MW waveguide for the adhesive bonding of a joint.

It is known that circularly polarized waves propagate differently, or experience a different absorption, in premagnetized ferromagnetic material. In the case of a rectangular waveguide in which a wave of the TE-(1.0) polarization type propagates, it is to be assumed that the following dispersion relations apply for propagation of the right-circular and left-circular wave components:

$${k}_{\pm }^{2} + \frac{{π}^{2}}{{b}^{2}} = \frac{1}{{c}^{2}} {ɛ}_{r} {ω}^{2} ( 1 - \frac{C γ {M}_{0} / 4 π}{\pm ( ω - \frac{i}{τ} ) - γ ( H + {H}_{A} )} )$$

where the (+) sign refers to right-circular waves and the (−) sign refers to left-circular waves, respectively. The variable k furthermore denotes the wavenumber of the MW along the adhesive joint, b denotes the width of the rectangular waveguide, c denotes the speed of light, i.e., 3×10⁸ m/s and ∈ᵣ denotes the average dielectric constant inside the waveguide, the dielectric constant of the part to be joined, the adhesive and air being weighted in proportion to the volume fraction of the waveguide and usually having values of somewhat more than 1. As is known, ω=2πf is the MW angular frequency, a frequency of f=2.45 GHz being employed in this example. C is the volume fraction of the nanoferrite, which makes up about 0.1% of the total volume of the waveguide. The saturation magnetization of the pure ferrite material is denoted by M₀, and is 280 mT in the case of NiZn ferrite. Furthermore, γ=2π×28 GHz/T denotes the gyromagnetic constant, H denotes the field strength of the applied DC magnetic field whose strength is about 70-80 mT, and H_{A} denotes the crystal anisotropy field of the ferrite material, here 5 to 20 mT. The spin relaxation time of the ferrite, denoted by τ, is typically 3-7 ns.

In the case of ferromagnetic resonance, i.e., when γ(H+H_{A})=ω, the dispersion relations for right-circular wave components in the limiting case C<0.01 result, to leading approximation in C, in an absorption rate or penetration depth (half-value length L) in the waveguide of

$${L}_{+} = \frac{1}{{Im k}_{+}} = \frac{16 {π}^{2} c}{C γ {M}_{0} ωτ}$$

and for left-circular waves

$${L}_{-} = \frac{1}{{Im k}_{-}} = \frac{16 {π}^{2} c}{C γ {M}_{0}}$$

The field amplitudes decay owing to MW absorption in the nanoferrite by the exponential law exp(−x/L_{+/-}) with increasing distance x from the feed-in point of the MW energy. In general, it is found that the ratio of the penetration depths of left- and right-circular wave components depends straightforwardly on the product of the MW angular frequency and the spin relaxation time:

$$\frac{{L}_{-}}{{L}_{+}} = ωτ$$

It follows that the right-circular wave components are absorbed more strongly by the factor χτ than the left-circular wave components. The method described here therefore works only with the proviso that ferrite materials having the property ωτ>>1 are used (see table below).

When using τ=6 ns and C=0.001 in the case of the nanoscale ferrite material Ni_{0.4}Zn_{0.6}Fe₂O₄, then the amplitude of the right-circular wave components has already decreased by 5% after a propagation distance of 50 cm. This means that 10% of the energy fed in is converted into heat in the adhesive joint via the right-circular wave components over the first 50 cm of the waveguide. On the other hand, the left-circular wave components are not attenuated by 5% until after 48 m. This means that only 0.1% is converted into heat over the first 50 cm.

FIG. 1 schematically shows a rectangular waveguide 1 with the section planes F₁ 2 and F₂ 3. For a TE-(1.0) wave set up inside the waveguide, the magnetic field components have the configuration indicated by 4 and migrate in the horizontal direction through the waveguide. In this example, the right-circular wave components (arrow A) migrate from the feed-in point at the left end to the far right end of the waveguide, and the left-circular waves conversely migrate from the right end back to the feed-in point. Only the wave traveling in the forward direction therefore contributes to heating the adhesive joint of a component lying in the resonator.

Suitable nanoferrites are those which have a relatively long spin relaxation time ωτ>>1. The evaluation of a ferrite material in respect of its suitability for the curing method according to the invention also depends on the frequency. The requirements at lower frequencies, e.g., 915 MHz, are generally more stringent than at high operating frequencies, e.g., 2.45 GHz or 5.8 GHz. It should nevertheless be remembered that the spin relaxation time τ is also not a fixed material constant, but tends to decrease slowly with increasing frequency.

The spin relaxation time τ may be determined for example by a spectroscopic method, the MW absorption at a constant frequency being determined as a function of an additionally applied magnetic field B. In this case, one or two absorption maxima which correspond to ferromagnetic resonance may be observed. The width ΔB of the absorption maxima is characteristic of the spin relaxation time τ, with: τ=2/ (γΔB).

The following table represents examples of nanoferrites with their parameters:

| | | | Saturation | | |
|---|---|---|---|---|---|
| | | | magnetization of the | Spin relaxation | ωτ |
| Nanoferrite | Modification | Adhesive | pure ferrite (M₀) | time (τ) | at f = 2.45 GHz |
| Ni_{0.4}Zn_{0.6}Fe₂O₄ | oleic acid | polyurethane | 280 mT | 6.5 ns | 100 |
| Mn_{0.7}Zn_{0.3}Fe₂O₄ | oleic acid | epoxy | 380 mT | 3.3 ns | 50 |
| Cu_{0.5}Zn_{0.5}Fe₂O₄ | oleic acid | polyurethane | — | 2.6 ns | 40 |
| Fe₃O₄ | oleic acid | PE Hotmelt | 450 mT | 0.8 ns | 12 |
| Co_{0.2}Zn_{0.8}Fe₂O₄ | TODS | Polyurethane | — | 0.1 ns | 1.5 |

The irradiation of an adhesive joined with circularly polarized waves by means of a split rectangular waveguide will be referred to as an application example. In this case, the distribution of the electric and magnetic fields of a wave with the TE-(1.0) polarization type traveling from left to right in the increasing x coordinate direction in a rectangular waveguide 1 as shown in FIG. 1, with a width b and a height h which extends in the x direction, is given as follows (“Theoretische Elektrotechnik” [Theoretical Electrical Engineering] by K. K üpfmüller, Springer-Verlag, Berlin 1973):
Hₓ=(Aπ/b)sin(ωt−kx)cos(πy/b)
H_{y}=Akcos(ωt−kx)sin(πy/b)
H_{z}=0
with Eₓ=0, E_{y}=0 and E_{z}=A′ sin(ωt−kx)sin π/b.

The y axis, as indicated in FIG. 1, points in the direction perpendicular to the waveguide axis and perpendicular to the electric field component, and the z axis likewise extends perpendicularly to the waveguide axis but is parallel to the electric field vector. The amplitudes A and A′ are not of further interest in this case.

On the imaginary section surface F₁2 through the waveguide, which lies in the x-z plane and cuts it at a height with the value y₁=(b/π arctan(π/kb)), the field components Hₓ and H_{y} have the same amplitude but are phase-shifted by 90° in their time profile. On the section surface F₁, the wave traveling through the waveguide in the positive x direction is therefore fully polarized right-circularly.

In the section surface F₂ 3 lying mirror-symmetrically opposite, which extends at the height of the y value Y₂=b−y₁, on the other hand, the wave is fully polarized left-circularly. If the wave is reflected back from the end of the waveguide, then the conditions for the reflection wave are exactly reversed. This fact is known and described for example in Philips Application Note No. AN98035, “Circulators and insulators, unique passive devices”, Philips Semiconductors, Marketing and sales communication, Building PE-b, P.O. Box 218, 5600 MD Eindhoven, NL.

If an adhesive joint is now placed along the section surface F₁ in the waveguide, for example by splitting it lengthwise at this height and fixing the two halves by means of a suitable mechanical device (FIG. 2) on the two sides of the parts 21 and 22 to be joined by adhesive bonding, then the conditions specified above in respect of the polarization of the microwaves, and the absorption by the nanoferrites admixed in the adhesive, prevail inside the adhesive joint. It is also necessary to apply DC magnetic field whose field lines are oriented in the z direction. This may be done by means of an electromagnet or a permanent magnet 26, in which case the magnetic field lines need to be guided over the sides of one of the two waveguide halves 24 and 25 to the section surface F₁ and into the adhesive joint. This can be done for example by means of a magnet with a U-shaped cross section.

FIG. 2 shows an embodiment of a MW waveguide for the adhesive bonding of a joint. The upper part 21 to be joined, the lower part 22 to be joined, the adhesive 23, which contains the MW-absorbing dichroic nanoferrites, and a removable upper half 24 of the waveguide are shown. The internal height is equal to y₁ less the thickness of the upper part to be joined and half the thickness of the adhesive joint. The lower half 25 of the waveguide has the internal height b−y₁ minus the thickness of the lower part to be joined and half the thickness of the adhesive joint. A field magnet 26 for premagnetizing the nanoferrite is also represented.

Preferred settings for the method or the device are given below. The strength B of the static magnetic field should lie between 0.1 mT and 10 T. A particularly preferred range is given by the relation B[T]=f [GHz]/28+/−20%. The method can be carried out effectively with electromagnetic radiation with a frequency of between 300 MHz-300 GHz, the range between 500 MHz-10 GHz being preferable, particularly the range between 700 MHz-3 GHz. Particles as described in DE 101 63 399 A1 may be used as nanoparticles. They should have a size of between 2 nm and 100 nm, preferably between 5 nm and 15 nm. The spin relaxation time preferably satisfies the condition τ>1/2πf, and τ>0.065 ns at 2.45 GHz. It is particularly preferable that τ>15/2πf and τ>1.0 ns at 2.45 GHz.

The circular polarization of the MW should furthermore lie in the adhesive joint region and the degree of polarization there should be at least 30%, preferably at least 60%. The angle between the polarization plane of the magnetic MW field component and the axis of the waveguide should be more than 45°, preferably more than 80°. The angle between the field lines of the additionally applied DC magnetic field and the normal to the polarization plane should be less than 45°, preferably less than 10°.

What is claimed is:

1. A method for manufacturing a component comprising at least two parts to be joined with an adhesive which can be cured by heat lying between the parts and forming an adhesive joint and which comprises a magnetic filler, said method comprising exposing at least one portion of the component to polarized electromagnetic radiation having a magnetic component which is circularly polarized so that heat is applied to the adhesive.

2. The method as claimed in claim 1, wherein the adhesive is sensitized with respect to the direction of polarization and essentially absorbs energy only from the waves with a particular polarization.

3. The method as claimed in claim 1, wherein the magnetic filler is comprised of magnetizable nanoparticles.

4. The method as claimed in claim 1, wherein the two parts to be joined are inside a waveguide designed as a resonator when said at least one portion of the component is exposed to polarized electromagnetic radiation, the cross-sectional geometry of said waveguide being designed so that the polarized electromagnetic radiation has a maximally pure circular polarization in the region of the adhesive joint.

5. The method as claimed in claim 4, wherein the magnetic field vector of the polarized electromagnetic radiation rotates in a plane that is oriented perpendicularly to the cross-sectional plane of the waveguide.

6. The method as claimed in claim 1, wherein circularly polarized waves are coupled into a resonator and a wave mode is excited inside the resonator.

7. The method as claimed in claim 1, wherein the component is exposed to a static magnetic field, which causes a premagnetization of the magnetic filler, at the position of the adhesive joint during the exposure of said component to polarized electromagnetic radiation.

8. The method as claimed in claim 7, wherein the direction of the static magnetic field inside the adhesive joint is oriented perpendicularly to the polarization plane.

9. The method as claimed in claim 7, wherein the static magnetic field has a strength in the range between 0.1 mT and 10 T.

10. The method as claimed in claim 1, wherein the polarized electromagnetic radiation has a frequency of between 300 MHz and 300 GHz.

11. The method as claimed in claim 1, wherein the magnetic filler has a spin relaxation time that is more than 1/2 πf.

12. The method as claimed in claim 1, additionally comprising taking precautions which prevent the dielectric heating from overcoming the temperature limitation due to the magnetic filler.

13. The method as claimed in claim 1, wherein at least one of a) the parts to be joined or b) said adhesive is comprised of one or more materials which prevent excessive dielectric MW absorption in the parts to be joined.

14. The method as claimed in claim 13, wherein at least one adhesive selected from the group consisting of polyurethane adhesives and epoxy adhesives is used in combination with at least one material selected from the group consisting of plastics, glass-fiber reinforced plastics, glass and ceramics.

15. The method as claimed in claim 1, wherein said component has a size of more than 10 cm.

16. The method as claimed in claim 1, wherein the polarized electromagnetic radiation has a degree of polarization of at least 30% in the region of the adhesive joint.

17. The method as claimed in claim 1, wherein the two parts to be joined are inside a waveguide and the angle between the polarization plane of the magnetic component and the axis of the waveguide is more than 45°.

18. The method as claimed in claim 1, wherein said magnetic filler is comprised of microwave-absorbing dichroic nanoscale ferrites.

19. A device comprising a means for applying heat to a component, the component having at least two parts to be connected with an adhesive joint arranged between said two parts, the adhesive joint containing an adhesive which can be cured by heat and the means for applying heat comprising a waveguide for electromagnetic radiation having a magnetic component, wherein the waveguide is designed so that the electromagnetic radiation coupled in through an opening has a circular polarization of the magnetic component.

20. The device as claimed in claim 19, wherein the waveguide is a rectangular waveguide in which a wave of the TE-(1.0) polarization type is set up.

21. The device as claimed in claim 19, wherein the waveguide is fitted to the component in such a way that the adhesive joint extends at a height of y=(b/π arctan(π/kb)) or at a height Y₂=b−y₁, the field components Hₓ and H_{y} having the same amplitude there and being phase-shifted by 90 ° in their time profile.

22. The device as claimed in claim 19, wherein the waveguide comprises two waveguide parts which enclose the component when. said two waveguide parts are assembled.

23. The device as claimed in claim 19, comprising a static magnet whose field lines inside the waveguide are oriented in the z direction.

24. The device as claimed in claim 19, wherein the waveguide comprises two waveguide parts which enclose the component when said two waveguide parts are assembled and the magnetic field lines are guided via the sides of one of the two waveguide parts into the adhesive joint.
